(19) United States
(12) Patent Application Publication
(10) Pub. No.: US 2025/0052108 A1
(43) Pub. Date: Feb. 13, 2025

(54) THERMAL REACTOR MOVABLE SHROUD

(71) Applicant: SAUDI ARABIAN OIL COMPANY, Dhahran (SA)

(72) Inventors: Ali H. Al-Nashmi, Dhahran (SA); Haytham A. Al-Barrak, Dhahran (SA)

(73) Assignee: SAUDI ARABIAN OIL COMPANY, Dhahran (SA)

(21) Appl. No.: 18/447,958

(22) Filed: Aug. 10, 2023

(51) Int. Cl. E06B 9/15

(52) U.S. Cl. CPC E06B 9/15

(57) ABSTRACT

A movable thermal shroud includes a mounting body with a framed opening, and a plurality of slats, each movably mounted to the mounting body in a stacked configuration and each slat extending across the length of the framed opening. An operation mechanism is configured to position the slats in the closed configuration or in the open configuration. A method for monitoring an inner equipment system includes placing a movable thermal shroud around the inner equipment system and moving the plurality of slats to the closed configuration using the operation mechanism to enclose the inner equipment system and moving the plurality of slats to the open configuration using the operation mechanism to access a portion of the inner equipment system.

### BACKGROUND

Thermal reactors are commonly designed with an external thermal shroud (sometimes referred to as a rain shield) mounted around the outer shell of the thermal reactor. Shrouds may be designed and fitted around the thermal reactor shell to maintain air flow between the shroud and the thermal reactor shell. Such air flow path may help to maintain a layer of warm air that may protect the shell from thermal shock due to significant changes in the surrounding environmental temperature. Additionally, shrouds are used to protect the thermal reactor shell from environmental conditions such as solar radiation, wind, and rain, that can significantly affect the shell temperature or cause the shell temperature to move out of an allowed temperature range for the thermal reactor shell. For example, when a thermal reactor has a carbon steel shell, high temperatures of about 650° F. may cause sulfidation corrosion of the shell and low temperatures below the acid dewpoint (e.g., less than about 350° F.) may cause acid corrosion.

FIGS. 1A and 1B demonstrate conventional thermal shroud design and function used with a system 100 including an external thermal shroud 102 protecting a thermal reactor 104 having a combustion chamber 112 enclosed by a refractory lining and a shell 106, where the shell 106 forms an outer surface of the thermal reactor 104. Conventionally, thermal reactors 104 are designed with a static external thermal shroud 102, as shown in FIGS. 1A and 1B, to protect the shell 106 from solar radiation, wind, and rain which can significantly affect the shell's 106 outer temperature.

FIG. 1B shows a functional schematic of the thermal shroud design according to prior art, where the thermal shroud 102 allows air flow from an ambient air inlet 114, around the outside of the thermal reactor 104. Hot air exits the thermal shroud 102 at an outlet 116. The space between the inner equipment and the shroud 102 allowing air flow from the inlet 114 to the outlet 116 may form a warm air flow blanket around the thermal reactor 104, helping to maintain the shell 106 metal temperature and also protect the shell 106 from thermal shock, which may occur from rain or cold winter conditions, for example.

While conventional shroud design may provide a warm air flow blanket formed between the inner equipment and shroud, such as shown in FIG. 1B, conventional shroud design does not provide access to the shell (or other outer surfaces) of thermal reactors such that the shell can be inspected fully during operation and equipment turnaround without physically dismantling and removing the shroud. To accommodate for such limited access to the thermal reactor, some systems have included many thermocouples installed externally around the thermal reactor to measure the temperature. However, in these systems, complete shell monitoring around the thermal reactor is still not possible. Thus, the limited access to conventional thermal reactor systems can lead to undetected hot or cold spots along the thermal reactor shell, which can cause damage to the shell.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a movable thermal shroud, including a mounting body with a framed opening having an area defined between a height and a length. The movable thermal shroud includes a plurality of slats, each having a first end and a second end opposite the first end, where the plurality of slats are movably mounted to the mounting body at the first end and at the second end and are movable relative to the mounting body between a closed configuration and an open configuration. The plurality of slats are mounted to the mounting body in a stacked configuration along the height of the framed opening and each of the plurality of slats extend across the length of the framed opening. The movable thermal shroud includes an operation mechanism, wherein the operation mechanism is configured to position the plurality of slats in the closed configuration or in the open configuration.

In another aspect, embodiments disclosed herein relate to a movable thermal shroud including a mounting body with an elongated member rotatable about a rotational axis. The movable thermal shroud contains a plurality of slats, each having a first end, a second end opposite the first end, and opposite sides extending between the first end and the second end and the plurality of slats are connected together at the opposite sides in a side-by-side configuration, and a first slat of the plurality of slats is connected to the elongated member. When the elongated member is rotated to a closed configuration, the plurality of slats hang from the elongated member and enclose an inner equipment system, and when the elongated member is rotated to an open configuration, at least a portion of the plurality of slats are wrapped around the elongated member, and a portion of the inner equipment system is accessible. The movable thermal shroud also includes an operation mechanism, where the operation mechanism is configured to rotate the elongated member between the closed configuration and the open configuration.

In another aspect, embodiments disclosed herein relate to a method for monitoring an inner equipment system by placing a movable thermal shroud around the inner equipment system. The movable thermal shroud includes a mounting body, and a plurality of slats connected to the mounting body, where the plurality of slats are movable relative to the mounting body between a closed configuration and an open configuration. The plurality of slats are held in a stacked configuration relative to each other. The movable thermal shroud also includes an operation mechanism configured to position the plurality of slats in the closed configuration or in the open configuration. The method also includes moving the plurality of slats to the closed configuration using the operation mechanism to enclose the inner equipment system and moving the plurality of slats to the open configuration using the operation mechanism to access a portion of the inner equipment system.

Other aspects and advantages of the claimed subject matter will be apparent from the following description and the appended claims.

### BRIEF DESCRIPTION OF DRAWINGS

FIG. 1A shows a conventional thermal shroud design.

FIG. 1B shows a functional schematic of a conventional thermal shroud design.

FIG. 2A shows a generic movable thermal shroud system and mechanism of operation according to one or more embodiments disclosed herein.

FIG. 2B shows a plurality of slats on a movable thermal shroud apparatus operated in the closed configuration according to one or more embodiments disclosed herein.

FIG. 2C shows a plurality of slats on a movable thermal shroud apparatus operated in the open configuration according to one or more embodiments disclosed herein.

FIG. 3A-3C show examples of multi-louver movable thermal shroud designs according to one or more embodiments disclosed herein.

FIGS. 4A-B show an example of a rolling or folding movable thermal shroud design according to one or more embodiments disclosed herein.

FIG. 5 shows a method for monitoring an inner equipment system using any of the movable thermal shroud designs of one or more embodiments disclosed herein.

FIG. 6 shows a computer system in accordance with one or more embodiments of the present disclosure.

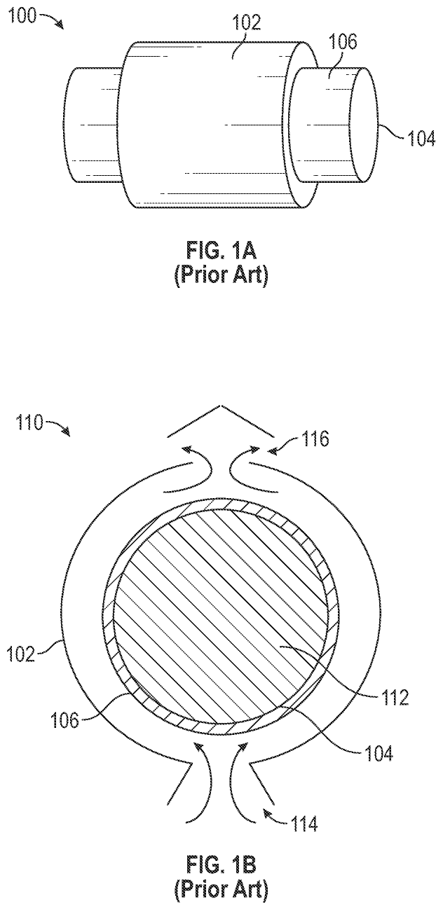

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” “about,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In the following description of the figures, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Embodiments disclosed herein generally relate to movable thermal shrouds and systems and methods of their use. Movable thermal shrouds disclosed herein may include a plurality of slats that are movable relative to a mounting body. The slats may be connected to the mounting body in such a manner that the slats may be moved between an open configuration and a closed configuration while the mounting body remains in a fixed position.

Movable thermal shrouds according to embodiments of the present disclosure may provide a resolution to current field challenges of inspecting and maintaining a thermal reactor or furnace. For example, a movable thermal shroud according to embodiments of the present disclosure may be positioned around a thermal reactor, where the mounting body of the movable thermal shroud may remain in a fixed position relative to the thermal reactor while the slats are moved relative to the mounting body (and thermal reactor) between their open and closed configurations. In such manner, the movable thermal shroud may permit visibility and accessibility to the thermal reactor external shell during normal operation, routine thermal infrared scanning (refractory monitoring), and startup and shutdown inspection without dismantling the shroud.

Measuring the shell outside temperature (for example, continuous online temperature measurement) of thermal reactors and other process equipment is done to ensure safety and to avoid equipment failure during normal operation and start-up and shutdown. For example, continuous monitoring of process equipment external shell temperature may be a safety requirement to ensure no hot or cold spots and no toxic gases (e.g., H₂S) are released during operation. The consequences of undetected failures in the reactor shell in a timely manner during operation can be very serious in terms of personnel safety, assets integrity and can lead to costly unplanned shutdown. Sudden equipment failure due to high temperature occurs in the field and results in safety risk, operation disruption, and financial losses.

For example, in two case studies of failed thermal reactors, where hotspots were not detected during operation, the thermal shroud was one of the causal factors contributing to the failure in both incidents because the thermal shrouds covered the thermal reactor shells and prevented inner equipment visibility. In the first case study, a thermal oxidizer sulfur recovery unit (SRU) experienced a hot spot in its outer shell during startup, which led to damage and a shell opening. The hot spot was not detected until the entire outer shell was glowing red around the sides of the fixed shroud and damage was apparent. In the second case study, another thermal reactor experienced an emergency shutdown due to an open flame at the top section of the thermal reactor, which was caused by high flame temperature in the thermal reactor during the reactor startup. The open flame was not observed because a conventional thermal shroud was covering the thermal reactor's shell, and two internal refractory layers and the carbon steel external shell of the thermal reactor were completely melted. In both case studies, the equipment external shells were damaged and melted where the thermal shroud acted as an obstacle to the operator's visibility.

While conventional shroud design typically requires shroud removal or disassembly for conducting inspection activities, movable thermal shrouds disclosed herein will allow operators and inspectors to have easy access to the inner equipment's external shell (or other outer surfaces) to conduct inspection activities. Inspection activities may include, for example, thermography, routine thermal scan (refractory integrity monitoring) inspection, visual inspection, and verifying the cause of a temperature change. Inspection activities may also include remediation, to make appropriate actions before reaching a temperature limit that damages the surface and causes a dangerous field condition. The ability to fully inspect and monitor the external shell of a thermal reactor or other high temperature equipment system may occur during normal operation and critical operation scenarios (startup and shutdown). Movable thermal shroud design according to embodiments of the present disclosure allows inspection and monitoring without having to shut down the operation process, thereby reducing maintenance time with no need for removals and re-installation. Additionally, movable thermal shrouds according to embodiments of the present disclosure can be opened and closed easily without affecting the shroud performance, which may also enhance the equipment integrity and refractory monitoring.

One or more embodiments relate to a movable thermal shroud apparatus. The movable thermal shroud may include at least a mounting body, a plurality of slats, and an operation mechanism. When positioned around an inner equipment system (e.g., a thermal reactor or other high temperature equipment), a movable thermal shroud according to embodiments of the present disclosure may enclose or entirely surround a section of an outer shell of the inner equipment system. One or more embodiments also relates to a method for monitoring an inner equipment system using a movable thermal shroud.

A movable thermal shroud of one or more embodiments may be positioned in an open or closed configuration, such that the inner equipment system is accessible when in the open position. The movable nature of movable thermal shrouds disclosed herein may provide the advantage of more readily providing visibility and accessibility to the inner equipment system as compared to conventional static thermal shrouds because conventional static thermal shrouds typically do not provide access to the inner equipment system without physically dismantling and removing the shroud. The ability to readily access the inner equipment system using the movable thermal shroud of one or more embodiments (e.g., by merely opening/closing slats of the movable thermal shroud) may provide the advantage of ease of monitoring and inspection, and prevention of damage to the inner equipment system during operation.

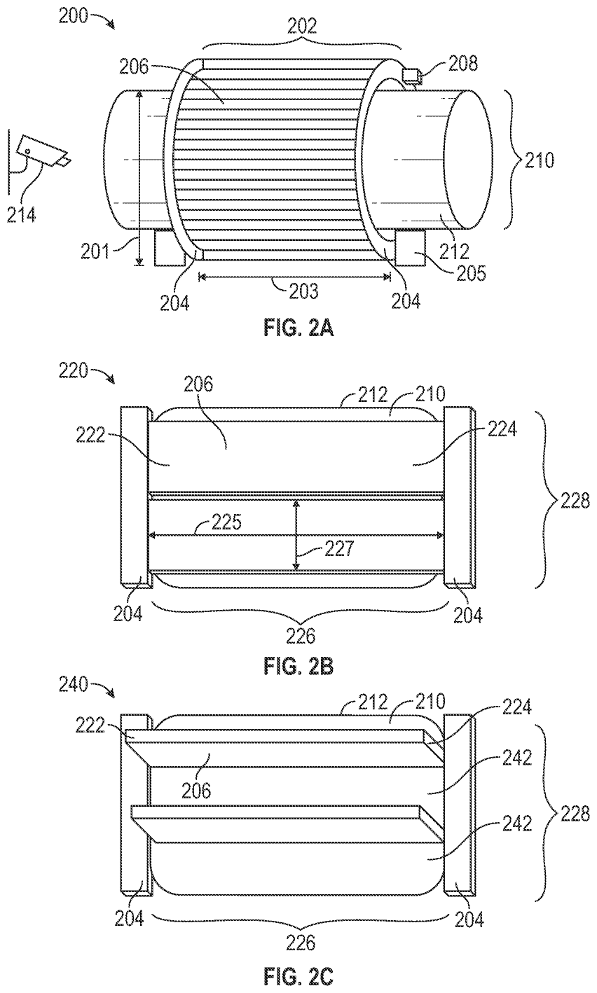

FIGS. 2A-2C show a generic movable thermal shroud system and mechanism of operation according to one or more embodiments disclosed herein. The system 200 of FIG. 2A includes a movable thermal shroud 202 which encloses a section of an outer surface 212 of an inner equipment system 210 and an infrared (IR) camera 214 located outside of the system 200 which monitors the temperature of the inner equipment system 210. In one or more embodiments, the enclosed section of the inner equipment system 210 may include a thermal reactor. In the embodiment shown, the movable thermal shroud 202 extends in a first dimension around a height 201 of the inner equipment system 210 and in a second dimension along a length 203 of the inner equipment system 210 to surround the section of the inner equipment system having the height 201 and length 203. The size and shape of the movable thermal shroud 202 may be designed to entirely surround the selected section of the inner equipment system while also allowing a space between the outer surface 212 of the inner equipment system 210 and the movable thermal shroud 202. In one or more embodiments, the space between the inner equipment system 210 and the movable thermal shroud 202 may have a substantially uniform radial distance around the entire enclosed section of the inner equipment system 210. Such space may allow thermally protective airflow between the inner equipment system 210 and the movable thermal shroud 202.

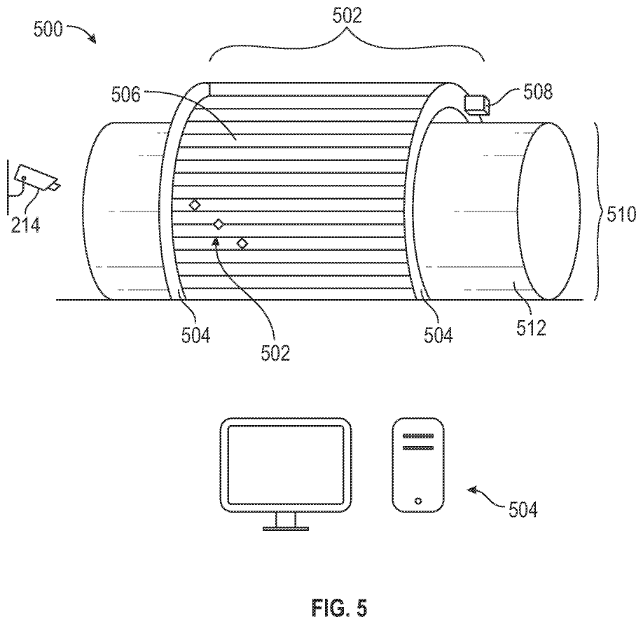

One or more legs 205, brackets, or other assembly equipment may be used for assembly of the movable thermal shroud 202 around the inner equipment system 210. In some embodiments, a movable thermal shroud 202 may sit on the ground and may extend upwardly from the ground and around a section of an inner equipment system to enclose the section of the inner equipment system (e.g., as shown in FIG. 5).

Keeping with FIGS. 2A-C, the movable thermal shroud 202 includes a mounting body 204, a plurality of slats 206 movably mounted to the mounting body 204, and an operation mechanism 208. In the embodiment shown, the mounting body 204 contains a framed opening having an area defined between a frame height 228 and a frame length 226, where the plurality of slats 206 extend in a parallel configuration across the framed opening. The slats 206 are movably mounted to the mounting body 204, operable between a closed configuration and an open configuration, as will be described in more detail in FIGS. 2B and 2C. The operation mechanism 208 is configured to position the plurality of slats 206 in the closed configuration or in the open configuration. For example, in one or more embodiments, the operation mechanism 208 may include a line (e.g., string or wire) connected to an end of each of the slats 206 and a pully (not shown) positioned internally in the mounting body 204. An operation mechanism handle positioned along an exterior of the mounting body (e.g., in an accessible location) may be connected to the pully, such that rotation of the operation mechanism handle may rotate the pully, thereby moving the line around the pully. In one or more embodiments, the line may be connected at the end of the slats, proximate a same lateral side of the slat ends, such that movement of the line by the pully moves the connected lateral side of the slats in an open or closed direction relative to the opposite lateral side of the connected end.

FIGS. 2B and 2C show a portion of the movable thermal shroud 202, where the plurality of slats 206 in a closed configuration 220 and in an open configuration 240, respectfully. In FIG. 2B, the plurality of slats 206 are in the closed configuration 220, enclosing a selected section of an inner equipment system 210. The plurality of slats 206 each have a slat length 225 measured between opposite axial sides at a first end 222 and a second end 224 opposite the first end 222, and a slat height 227 measured between opposite lateral sides. In the embodiment shown in FIGS. 2B-C, the plurality of slats 206 are movably mounted to the mounting body 204 at the first end 222 and at the second end 224, such that the slat length 225 extends across the frame length 226 of the mounting body 204 and are movable relative to the mounting body 204 between a closed configuration 220 and an open configuration 240. Additionally, the slats 206 may be mounted to the mounting body 204 in a stacked configuration relative to each other along the frame height 228 of the framed opening, such that the opposite lateral sides of each slat 206 are parallel with and next to each other. When the slats 206 are in the closed configuration 220, the lateral sides of each slat 206 may be adjacent to (e.g., in contact with, or with a maximum space therebetween that allows relative movement of the slats) or overlapping with neighboring slats 206. In one or more embodiments, the maximum space between adjacent lateral sides when the slats are in a closed configuration may be minimized to maximize protection of the inner equipment system from solar radiation, rain, winds, etc. Therefore, when the plurality of slats 206 are in the closed configuration 220 of FIG. 2B, the area of the framed opening is substantially or entirely covered by the slats, and thus also the outer surface 212 of the enclosed inner equipment system section is substantially or entirely covered by the slats. The closed configuration 220 of FIG. 2B represents the positioning of the plurality of slats 206 of the movable thermal shroud 202 during normal operation, for example.

In FIG. 2C, the plurality of slats 206 are in the open configuration 240, exposing a portion of the inner equipment system 210. In one or more embodiments, at least 80% of the area of the framed opening (e.g., 80-99%) may be open when the slats 206 are in the open configuration 240. The exposed area of the framed opening may provide visibility to the outer surface 212 of the inner equipment system, as defined by an exposed area 242 measured between the open slats 206 from a radially outer perspective. Moving the plurality of slats 206 into the open configuration 240 and exposing a portion of the framed opening renders the inner equipment system 210 accessible. The open configuration 240 of FIG. 2C represents the positioning of the plurality of slats 206 of the movable thermal shroud 202 during monitoring or maintenance, for example.

In some embodiments, the slats 206 may be opened by moving to a perpendicular position relative to their closed configuration, where in the closed configuration, the slat height 227 extends in an initial direction, and in the open configuration, the slat height 227 extends in a perpendicular direction to the initial direction. By moving the slats to rotate their slat height direction about 90 degrees between the open and closed configurations, a relatively larger exposed area of the framed opening may be provided to improve visibility through the movable thermal shroud 202.

FIGS. 2B-C show a planar portion of a movable thermal shroud 202. However, in one or more embodiments, the movable thermal shroud 202 may have a non-planar mounting body 204. When slats 206 are mounted along a planar portion of a mounting body 204 (extending along a first plane), the slats may be substantially co-planar with the planar portion of the mounting body 204 when the slats 206 are in the closed configuration 220, and the slats 206 may extend in a substantially perpendicular direction (perpendicular to the first plane) to the planar portion of the mounting body 204 when the slats 206 are in the open configuration 240. In some embodiments, slats 206 are mounted along a curved, angled, or other non-planar portion of a mounting body extending in a first dimension (e.g., height dimension) and a second dimension (e.g., length dimension) perpendicular to the first dimension. In such embodiments, the slats 206 may be mounted to the mounting body such that the slat length of each slat extends parallel with the mounting body frame length, along the second dimension. Additionally, when mounted along a non-planar portion of the mounting body, the slats 206 may move between the open and closed configurations, where the axial sides of each slat are substantially aligned with the mounting body along the first dimension when in the closed configuration, and where the axial sides of each slat may extend perpendicularly from both the first and second dimensions when in the open configuration.

In one or more embodiments, at least one sensor may be positioned on the outer surface 212 of the inner equipment system 210. The sensor or sensors may be configured to measure one or more environmental parameters, for example, the environmental parameter may be selected from the group consisting of temperature, humidity, wind speed, pressure, and toxic gas level. The sensor may also be configured to detect a position of the slats 206, such as if the slats are in the open configuration or in the closed configuration. In some embodiments, one or more first sensors measuring a first environmental parameter may be positioned upon the outer surface 212 of the inner equipment system 210, and one or more second sensors measuring a second environmental parameter may be positioned upon the outer surface 212 of the inner equipment system 210.

The movable thermal shroud of one or more embodiments may provide protection to an inner equipment system during normal operation. The movable thermal shroud may be used either indoors or outdoors in industrial facilities such as petrochemical plants, refineries, gas plants, and the like, or any other suitable facility or application. The movable thermal shroud may provide protection from weather conditions such as solar radiation, wind, rain, temperature changes, dust, dirt, or other natural or man-made conditions created indoors or outdoors.

The inner equipment system may be any inner equipment system known in the art. For example, the inner equipment system may be a tank, a reactor, a thermal reactor, a nuclear reactor, a thermal oxidizer, a furnace, a pressure vessel, and the like.

In one or more embodiments, the outer surface of the inner equipment system may be a shell, casing, or any other protective layer known in the art.

In one or more embodiments, the mounting body may be any shape or mechanical construction capable of having a plurality of slats movably mounted to the mounting body. The shape of the mounting body may be, for example, a cubic or other polygonal cage or may be cylindrical, semi-cylindrical, or domed. The mounting body may be further define a framed opening having an area defined by a height and a length, e.g., a planar polygonal area (e.g., a rectangular area), a curved polygonal area (e.g., a convex rectangular area), or other curved or planar area. A plurality of slats may be movably mounted in parallel with a dimension (e.g., the length) of the mounting body.

In one or more embodiments, the plurality of slats may be constructed in any size, shape, or geometry to allow the plurality of slats to be movably mounted to the mounting body and operable in an open configuration and a closed configuration. For example, the plurality of slats may have a slat length in a range of from about 1000 mm to about 2000 mm, a slat height in a range of from about 50 mm to about 250 mm, and a slat thickness in a range of from about 1 mm to about 2.5 mm.

In one or more embodiments, the plurality of slats may be made of any suitable material known in the art. The material may be metallic or non-metallic. Examples of slat materials may include, but are not limited to, stainless steel, aluminum, carbon steel, or non-metallic composites.

The operation mechanism of one or more embodiments may be different types of operation mechanisms that are capable of moving connected slats between an open and closed configuration. For example, the operation mechanism may be a line and pulley-type operation mechanism, a handle or lever, a pull string, a mechanical button, a crank, wheel, or any other suitable operation mechanism.

The operation mechanism of one or more embodiments may be provided in different locations along the movable thermal shroud which allows for ease of access and for the operation mechanism to open/close the slats of the movable thermal shroud. In some embodiments, the operation mechanism may be manually or mechanically operated. In some embodiments, the operation mechanism may be automatically operated (e.g., upon receiving signal(s) from a computer system).

The IR camera (e.g., IR camera 214) of one or more embodiments may be any suitable temperature monitoring tool known in the art. The IR camera may be used to monitor the temperature of the outer surface of the inner equipment system by measuring the shell temperature and to check refractory integrity. Having the movable shroud design in an open configuration provides accessibility and exposure of the inner equipment system to the IR camera, thereby providing access to the inner equipment system for online monitoring through the IR camera. In one or more embodiments, having the movable shroud in an open configuration allows for accessibility and monitoring of the inner equipment system using other techniques such as visual inspection, in addition to other measurements and inspection during equipment turnaround (thickness measurement and shell inspection) without the needs for the shroud dismantle. In addition, having movable thermal shroud may allow for optimization of the refractory thickness design in an inner equipment system.

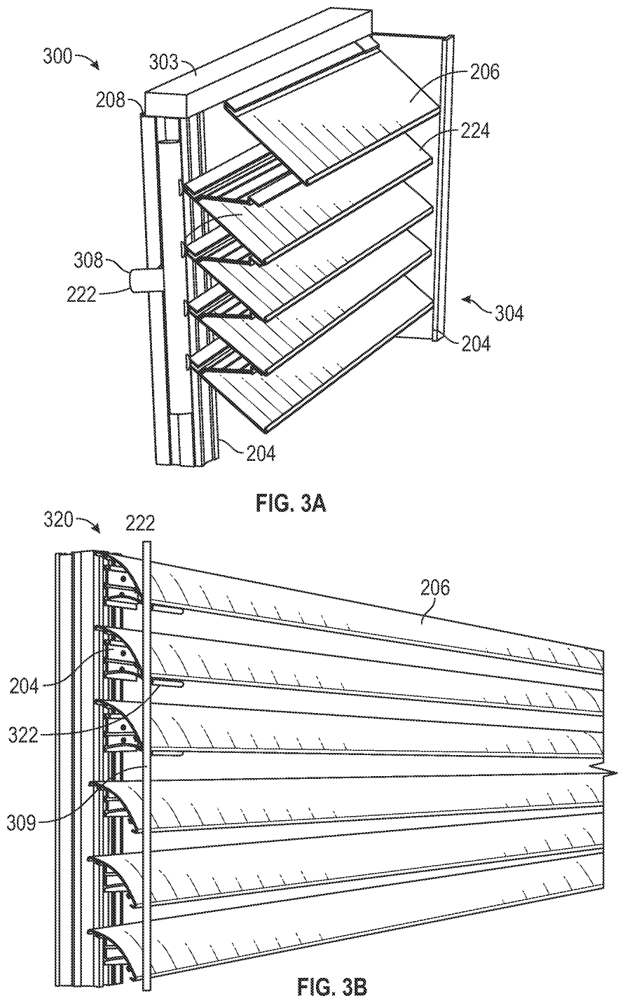

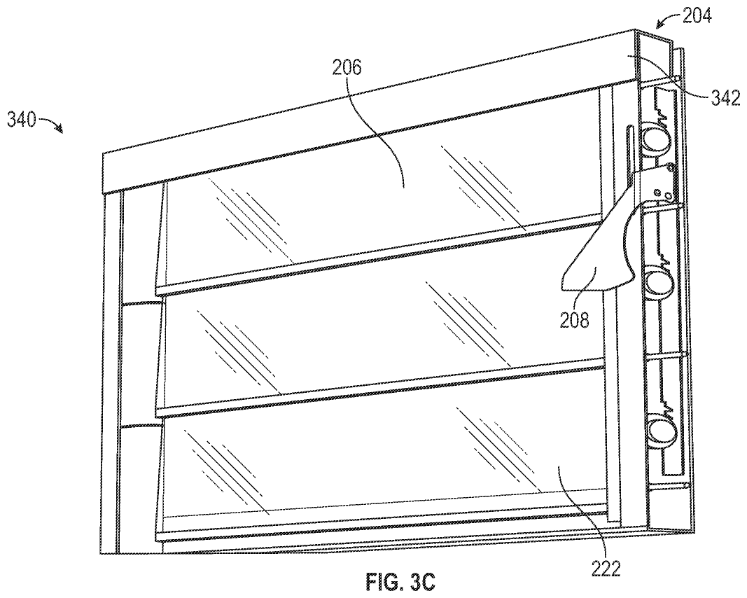

FIGS. 3A-3C show examples of multi-louver movable thermal shroud designs according to one or more embodiments disclosed herein. FIG. 3A shows one example of a multi-louver movable thermal shroud design according to one or more embodiments. In FIG. 3A, the mounting body 204 includes a first side 302 and a second side 304 of a framed opening. In FIG. 3A, an internal view of the first side 302 is shown to demonstrate an example of an operation mechanism 308 that may be used to move a plurality of connected slats between an open and closed configuration within the framed opening. Each of the plurality of slats 206 are movably connected with the first end 222 to the first side 302 of the mounting body 204 and the second end 224 to the second side 304 of the mounting body 204. In the example embodiment shown, the operation mechanism 308 includes a connecting rod that is slidably mounted in the first side 302 of the mounting body. The connecting rod may be connected (e.g., welded) proximate to a same lateral side of the slats 206 at the first end 222 of the slats. The opposite lateral sides of adjacent slats 206 may be connected via a clip member, and a first slat may be connected to a top side 303 of the mounting body. Such assembly may allow for the same lateral side of the slats (connected to the connecting rod) to be moved relative to the opposite lateral sides of the slats, thereby moving the slats between the open and closed configurations. In one or more embodiments, the connecting rod may have an operation mechanism handle extending external to the mounting body, such that the operation mechanism handle is accessible for moving the connecting rod.

FIG. 3B shows another example of a multi-louver movable thermal shroud design according to one or more embodiments. In FIG. 3B, the mounting body 204 includes a plurality of clip members 322 connected at a hinged connection to the mounting body 204 and connected to a same lateral side of the slats 206 at the first end 222 of the slats. For example, each of the plurality of slats 206 may be connected at least at the first end 222 by seating or clipping the same lateral side in each of the plurality of clip members 322 of the mounting body 204. In such assembly, each clip member 322 may extend from the hinged connection at the mounting body 204 to a same lateral side of each slat 206. An operation mechanism 309 including a connecting rod may be connected to each of the clip members 322 proximate the same lateral side of the slats 206. Axial movement of the connecting rod correspondingly moves the same lateral side of the slats 206 relative to a fixed location hinged connection at the mounting body, thereby positioning the plurality of slats 206 in the closed configuration or in the open configuration.

Examples of operation mechanisms utilizing a connecting rod are shown in FIGS. 3A and 3B; however, other configurations of operation mechanisms may be used to move a plurality of slats in an open and closed configuration. For example, an operation mechanism may include interlocking gears or a pully assembly connected directly or indirectly to all of the clip members, where movement of the operation mechanism (e.g., manual movement by a user or movement initiated by a signal from a computer system) moves all of the connected clip members to rotate downward (thereby moving the mounted slats to a closed configuration) or to rotate upward (thereby moving the mounted slats to an open configuration).

FIG. 3C shows another example of a multi-louver movable thermal shroud design according to one or more embodiments. In FIG. 3C, the mounting body 204 includes a mounting frame 342. Each of the plurality of slats 206 are movably connected in parallel to the mounting frame 342. In the movable thermal shroud design of FIG. 3C, the operation mechanism may include a lever or handle 307 which is operatively connected to at least the first end 222 of the plurality of slats 206 and is configured to position the plurality of slats in the open configuration and the closed configuration. For example, in one or more embodiments, the first end 222 of the slats 206 may each be connected to a first side of the mounting frame 342 at a slat pivot point (e.g., at a midpoint along the first end of the slat), and the handle 307 may be operatively connected (e.g., via an attached wire or connecting rod) to the first end 222 of each slat 206 at a point along the first end spaced from the slat pivot point. In such embodiments, when the handle 307 is moved in a first direction, the connected points of the slat first ends 222 each move in the first direction with the movement of the connected handle 307, thereby pivoting each slat in the first direction about the slat pivot point.

As described with respect to the thermal shroud system and mechanism of operation in FIGS. 2A-2C, the multi-louver movable thermal shroud designs 300, 320, 340 according to FIGS. 3A-3C may also enclose a section of an outer surface 212 of an inner equipment system 210, extending in a first dimension around a height 201 of the inner equipment system 210 and in a second dimension along a length 203 of the inner equipment system 210. The multi-louver movable thermal shroud designs according to FIGS. 3A-3C also includes a framed opening defined by an area of the mounting body 204 having a frame height 228 and a frame length 226. The plurality of slats 206 may be mounted in a stacked configuration relative to each other along the frame height 228, extending across the length 226 of the framed opening. The multi-louver moveable thermal shroud designs of FIGS. 3A-3C allow for at least 80% exposure of the area of the framed opening (e.g., 80-99%) when the plurality of slats 206 are in the open configuration 240.

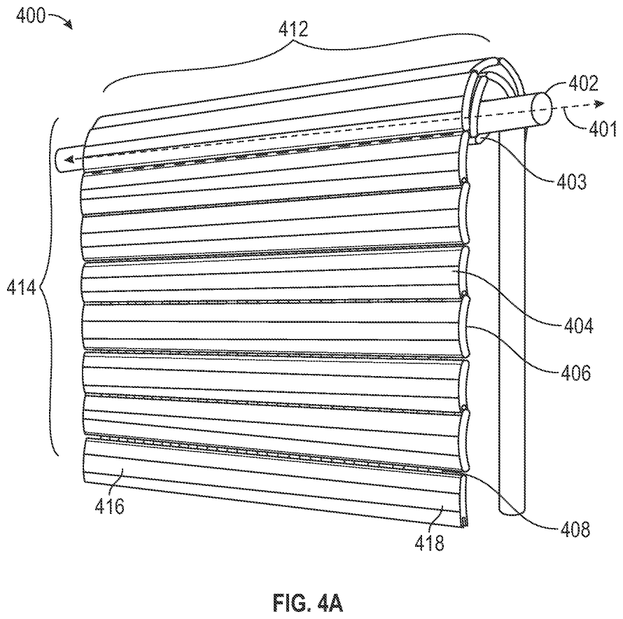

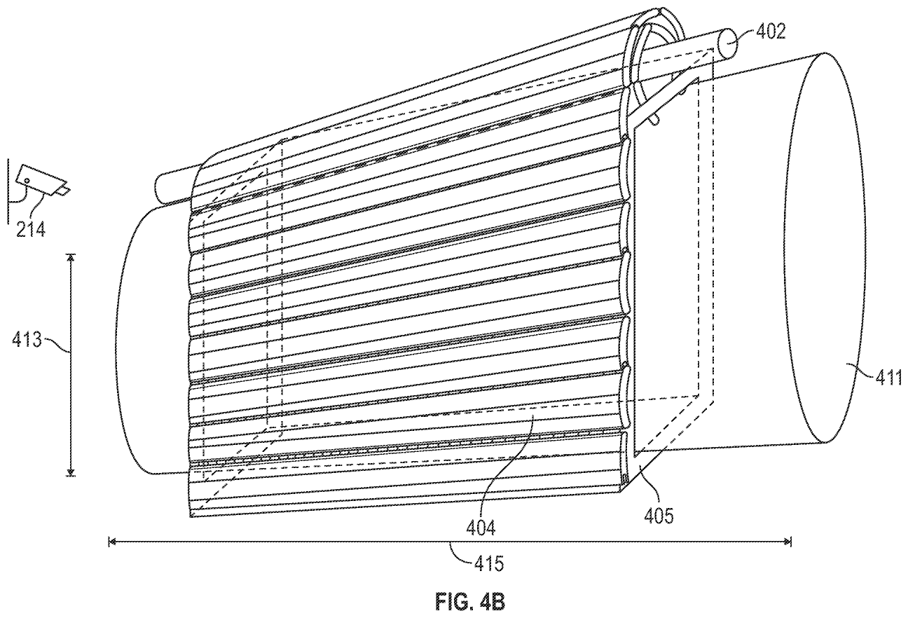

FIGS. 4A-B show an example of a rolling or folding movable thermal shroud design according to one or more embodiments. In FIGS. 4A-B, the movable thermal shroud 400 includes a mounting body having an elongated member 402, which is used to open and close a plurality of slats 404. As shown in FIG. 4B, an IR camera 214 may be located outside of the system 200 which monitors the temperature of the inner equipment system 411. In some embodiments, the elongated member 402 may be a cylindrical rod. The elongated member 402 may be rotatably mounted to a frame 405 of the mounting body, where the elongated member 402 is rotatable about a rotational axis 401. For example, an elongated member may be rotatable via an operation mechanism including a motor and/or gear assembly provided with the mounting body. In some embodiments, the operation mechanism may include a different torquing or rotational motor assembly. In some embodiments, the operation mechanism may be a handle that is rotated to manually rotate the elongated member relative to the remaining mounting body frame.

The movable thermal shroud 400 also includes a plurality of slats 404 connected to the elongated member 402 via a first slat 403. For example, the first slat 403 may be welded, tied, or otherwise connected to the elongated member 402 to hold the first slat 403 parallel with the elongated member 402, such that the first slat 403 extends across a length 412 of the elongated member 402. Each of the slats 404 have a first end 416 and a second end 418 opposite the first end 416 and opposite lateral sides 408 extending between the first end 416 and the second end 418. In some embodiments, the plurality of slats 404 may be formed of a large sheet (such as a corrugated sheet) having channels 406 dividing the slats 404. The channels 406 may be lines of weakened or bendable portions of the sheet, such as linear grooves or perforated lines. In some embodiments, the slats 404 are connected together at opposite lateral sides 408 in a side-by-side configuration. For example, wire may be strung through the slat height of each slat to string the slats on the wire in the side-by-side configuration.

The channels 406 allow the sheet of slats 404 to roll around the elongated member 402 as the elongated member 402 is rotated about its rotational axis 401, where each channel 406 may act as a linear bend point as the sheet of slats 404 is rolled around the elongated member 402. Elongated members may have different sizes depending on the size of the mounting body, the size of the inner equipment system, and the size/amount of slats to be rotated around the elongated member. For example, an elongated member may have a diameter ranging from about 10 to 100 mm. When the elongated member 402 is rotated to a closed configuration, the plurality of slats 404 hang from the elongated member 402 and enclose at least a section of an inner equipment system 411. When the elongated member 402 is rotated to an open configuration, at least a portion of the plurality of slats 404 are wrapped around the elongated member 402 and a portion of the inner equipment system 411 is accessible. The movable thermal shroud 400 of FIG. 4 also includes an operation mechanism 410 configured to rotate the elongated member 402 between the closed configuration and the open configuration. In some embodiments, the operation mechanism may be manually operated. In some embodiments, the operation mechanism may be automatically operated.

The rolling or folding moveable thermal shroud design 400 according to FIGS. 4A-B may enclose a section of an inner equipment system 411, extending in a first dimension around a height 413 of the inner equipment system 411 and in a second dimension along a length 415 of the inner equipment system 411. The rolling or folding movable thermal shroud design 400 according to FIGS. 4A-B contains a framed opening having a maximum area defined by a length 412 of the elongated member 402 and a height 414 at which the elongated member 402 is rotatably mounted along the mounting body frame. The rolling or folding movable thermal shroud design 400 according to FIG. 4 allows for at least 80% exposure of the maximum area described above (e.g., 80-99%) when the plurality of slats 404 are in the open configuration (for example, when rolled or folded onto the cylindrical member 402). In some embodiments, the rolling or folding moveable thermal shroud design 400 according to FIGS. 4A-B allows for 100% exposure of the maximum area described above when the plurality of slats 404 are in the open configuration (for example, when the slats are entirely rolled or folded onto the cylindrical member 402).

In one or more embodiments, the mounting body of the rolling or folding movable thermal shroud design may be any shape or mechanical construction capable of having a plurality of slats movably mounted to the mounting body. For example, the mounting body may have a frame with a cylindrical shape, where the slats may be moved around cylindrical side of the frame. In some embodiments, such as shown in FIG. 4B, the mounting body frame 405 may have a rectangular framed opening extending greater than the height 413 of an inner equipment system 411, where the elongated member 402 may be rotatably mounted at the top of the framed opening. In such configuration, the sheet of slats 404 may be raised (opened) and lowered (closed) by rotation of the elongated member 402 to expose and enclose, respectively, the inner equipment system 411.

The size of the mounting body may vary based on the size of the inner equipment system. For example, the mounting body frame 405 in FIG. 4B may have a framed opening with a length 412 extending between 80-100% of the length 415 of a portion of the inner equipment system containing a high temperature equipment unit (e.g., a thermal reactor) and a height 413 extending between greater than 100% to about 110% of the portion of the inner equipment system being enclosed. For example, a framed opening may have a length 412 and/or height 413 ranging from about 700 mm to about 3,000 mm.

In one or more embodiments, the plurality of slats of the rolling or folding movable thermal shroud design may be any shape or mechanical construction capable of being movably mounted to the mounting body. For example, the plurality of slats may be sectional with larges pieces or a single continuous sheet. The large pieces may include section panels connected together in a corrugated channel and sheet configuration, or any other method known in the art.

In some embodiments, rather than orienting slats in a horizontal configuration (e.g., where the slat length extends along a length dimension of the inner equipment system), the slats may be oriented in a vertical configuration. In a vertical configuration, the slats may operate in the same manner as described herein with respect to the horizontal configurations but are oriented in a different direction. For example, in one or more embodiments, a mounting body may have a framed opening extending a height above an inner equipment system and a length along the length of the inner equipment system, where a plurality of slats may be movably mounted along the framed opening in a vertical configuration having the slat lengths extend along the height dimension of the framed opening. In such embodiments, the slats may be moved laterally (in a direction along the length dimension) between an open and closed configuration.

In one or more embodiments, the plurality of slats may be metallic or non-metallic, and may be made of any suitable material known in the art, as described above.

FIG. 5 shows a method for monitoring an inner equipment system using any of the movable thermal shroud designs of one or more embodiments. In FIG. 5, a movable thermal shroud 502 is placed around an inner equipment system 510 and an IR camera 214 is located outside of the system 500 which monitors the temperature of the inner equipment system 510. The movable thermal shroud 502 includes a plurality of slats 506 movably mounted to a mounting body 504 and operated in an open configuration or a closed configuration using an operation mechanism 508. The movable thermal shroud 502 may be configured according to any of the movable thermal shrouds as described in previous sections. The method for monitoring an inner equipment system 510 includes moving the plurality of slats 506 to a closed configuration using the operation mechanism 508 to enclose a section of an outer surface 512 of the inner equipment system 510, for example, during normal operation. The inner equipment system 510 may then be made accessible by moving the plurality of slats 506 to an open configuration using the operation mechanism 508 to expose at least a portion of the enclosed section of the inner equipment system 510 for monitoring and maintenance, for example.

In some embodiments, the method for monitoring the inner equipment system 510 using the movable thermal shroud 502 of FIG. 5 also includes using at least one sensor 502 mounted to an outer surface 512 of the inner equipment system 510. The at least one sensor 502 may be configured to monitor an environmental parameter. In one or more embodiments, the environmental parameter is selected from the group consisting of temperature, humidity, wind speed, pressure, and toxic gas level. The at least one sensor may include a position sensor configured to detect a position of the plurality of slats 506, such as if the plurality of slats are in the open configuration or in the closed configuration. In some embodiments, a first plurality of sensors measuring a first environmental parameter may be positioned upon the outer surface 512 of the inner equipment system 510, and a second plurality of sensors measuring a second environmental parameter may be positioned upon the outer surface 512 of the inner equipment system 510.

Keeping with FIG. 5, in one or more embodiments, a computer system 504 may be used to interface with the at least one sensor 502 disposed on the outer surface 512 of the inner equipment system 510. The at least one sensor 502 provides indication of the environmental parameter and gives a warning to operation personnel in the field. In some embodiments, the computer system 504 is used to control the operation mechanism 508 based on the environmental parameter value obtained from the at least one sensor 502. In some embodiments, the operation mechanism 508 is manually operated based on the environmental parameter value. In other embodiments, the operation mechanism 508, which is controlled using the computer system 504, is mechanically operated and/or is configured to automatically move the plurality of slats 506 on the movable thermal shroud 502 into the open configuration or the closed configuration based on the environmental parameter value obtained from the at least one sensor 502. For example, the method for automatically moving the plurality of slats 506 on the movable thermal shroud 502 can be used to open the shroud automatically based on preset temperature (or certain weather condition) limit or during different operation condition (i.e., start up or shut down).

The at least one sensor of one or more embodiments may be a temperature or weather sensor, such as a pressure sensor or humidity sensor, and/or a gas detector (for example, to monitor H₂S or other toxic gas). The sensor may be configured to provide alarms and/or send signals to operate the shroud (open and close) as weather conditions dictate or once a hot or cold spot is detected.

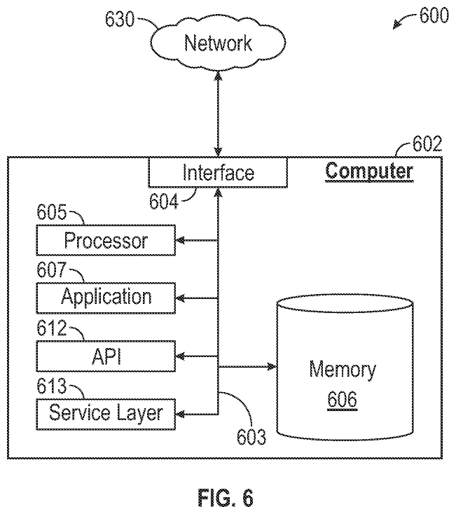

FIG. 6 is a block diagram of a computer system 600 used to provide computational functionalities associated with described algorithms, methods, functions, processes, flows, and procedures as described in the instant disclosure, according to an implementation. The illustrated computer 602 is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 602 may include an input device, such as a keypad, keyboard, touch screen, or other device that can accept user information, and an output device that conveys information associated with the operation of the computer 602, including digital data, visual, or audio information (or a combination of information), or a GUI.

The computer 602 can serve in a role as a client, network component, a server, a database or other persistency, or any other component (or a combination of roles) of a computer system for performing the subject matter described in the instant disclosure. The illustrated computer 602 is communicably coupled with a network 630. In some implementations, one or more components of the computer 602 may be configured to operate within environments, including cloud-computing-based, local, global, or other environment (or a combination of environments).

At a high level, the computer 602 is an electronic computing device operable to receive, transmit, process, store, or manage data and information associated with the described subject matter. According to some implementations, the computer 602 may also include or be communicably coupled with an application server, e-mail server, web server, caching server, streaming data server, business intelligence (BI) server, or other server (or a combination of servers).

The computer 602 can receive requests over network 630 from a client application (for example, executing on another computer 602) and responding to the received requests by processing the said requests in an appropriate software application. In addition, requests may also be sent to the computer 602 from internal users (for example, from a command console or by other appropriate access method), external or third-parties, other automated applications, as well as any other appropriate entities, individuals, systems, or computers.

Each of the components of the computer 602 can communicate using a system bus 603. In some implementations, any or all of the components of the computer 602, both hardware or software (or a combination of hardware and software), may interface with each other or the interface 604 (or a combination of both) over the system bus 603 using an application programming interface (API) 612 or a service layer 613 (or a combination of the API 612 and service layer 613. The API 612 may include specifications for routines, data structures, and object classes. The API 612 may be either computer-language independent or dependent and refer to a complete interface, a single function, or even a set of APIs. The service layer 613 provides software services to the computer 602 or other components (whether or not illustrated) that are communicably coupled to the computer 602. The functionality of the computer 602 may be accessible for all service consumers using this service layer. Software services, such as those provided by the service layer 613, provide reusable, defined business functionalities through a defined interface. For example, the interface may be software written in JAVA, C++, or other suitable language providing data in extensible markup language (XML) format or other suitable format. While illustrated as an integrated component of the computer 602, alternative implementations may illustrate the API 612 or the service layer 613 as stand-alone components in relation to other components of the computer 602 or other components (whether or not illustrated) that are communicably coupled to the computer 602. Moreover, any or all parts of the API 612 or the service layer 613 may be implemented as child or sub-modules of another software module, enterprise application, or hardware module without departing from the scope of this disclosure.

The computer 602 includes an interface 604. Although illustrated as a single interface 604 in FIG. 6, two or more interfaces 604 may be used according to particular needs, desires, or particular implementations of the computer 602. The interface 604 is used by the computer 602 for communicating with other systems in a distributed environment that are connected to the network 630. Generally, the interface 604 includes logic encoded in software or hardware (or a combination of software and hardware) and operable to communicate with the network 630. More specifically, the interface 604 may include software supporting one or more communication protocols associated with communications such that the network 630 or interface's hardware is operable to communicate physical signals within and outside of the illustrated computer 602.

The computer 602 includes at least one computer processor 605. Although illustrated as a single computer processor 605 in FIG. 6, two or more processors may be used according to particular needs, desires, or particular implementations of the computer 602. Generally, the computer processor 605 executes instructions and manipulates data to perform the operations of the computer 602 and any algorithms, methods, functions, processes, flows, and procedures as described in the instant disclosure.

The computer 602 also includes a memory 606 that holds data for the computer 602 or other components (or a combination of both) that can be connected to the network 630. For example, memory 606 can be a database storing data consistent with this disclosure. Although illustrated as a single memory 606 in FIG. 6, two or more memories may be used according to particular needs, desires, or particular implementations of the computer 602 and the described functionality. While memory 606 is illustrated as an integral component of the computer 602, in alternative implementations, memory 606 can be external to the computer 602.

The application 607 is an algorithmic software engine providing functionality according to particular needs, desires, or particular implementations of the computer 602, particularly with respect to functionality described in this disclosure. For example, the application 607 can serve as one or more components, modules, applications, etc. Further, although illustrated as a single application 607, the application 607 may be implemented as multiple applications 607 on the computer 602. In addition, although illustrated as integral to the computer 602, in alternative implementations, the application 607 can be external to the computer 602.

There may be any number of computers 602 associated with, or external to, a computer system containing computer 602, each computer 602 communicating over network 630. Further, the term “client,” “user,” and other appropriate terminology may be used interchangeably as appropriate without departing from the scope of this disclosure. Moreover, this disclosure contemplates that many users may use one computer 602, or that one user may use multiple computers 602.

In some embodiments, the computer 602 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

As discussed herein, conventional thermal shroud designs have challenges related to visibility and accessibility. However, movable thermal shrouds according to embodiments of the present disclosure may be movable (manually or automatically) relative to a fixed mounting body frame that allows inspectors to conduct inspection activities, operators to monitor the shell temperature, and personnel to perform inspection without the need of dismantling and reinstalling the thermal shroud.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A movable thermal shroud, comprising:
a mounting body comprising a framed opening having an area defined between a height and a length;
a plurality of slats, each having a first end and a second end opposite the first end,
wherein the plurality of slats are movably mounted to the mounting body at the first end and at the second end and are movable relative to the mounting body between a closed configuration and an open configuration,
wherein the plurality of slats are mounted to the mounting body in a stacked configuration along the height of the framed opening, and wherein each of the plurality of slats extend across the length of the framed opening; and
an operation mechanism, wherein the operation mechanism is configured to position the plurality of slats in the closed configuration or in the open configuration.

2. The movable thermal shroud of claim 1, wherein when the plurality of slats are in the open configuration, at least 80% of the area of the framed opening is open.

3. The movable thermal shroud of claim 1, wherein the operation mechanism is manually operated.

4. The movable thermal shroud of claim 1, wherein the operation mechanism is mechanically operated.

5. The movable thermal shroud of claim 1, wherein the movable thermal shroud encloses an inner equipment system, and at least one sensor is positioned on an outer surface of the inner equipment system.

6. The movable thermal shroud of claim 5, wherein the at least one sensor is selected from the group consisting of a temperature sensor, a humidity sensor, a pressure sensor, and a toxic gas detector.

7. The movable thermal shroud of claim 1, wherein:
the mounting body comprises a first side and a second side defining the framed opening;
each of the plurality of slats are movably connected with the first end to the first side of the mounting body and the second end to the second side of the mounting body; and
the operation mechanism comprises a line connected to each of the plurality of slats and a pully.

8. The movable thermal shroud of claim 1, wherein
the mounting body comprises a plurality of clip members;
wherein each of the plurality of clip members are connected to the first end of the plurality of slats at a first lateral side of each of the plurality of slats; and
the operation mechanism comprises a connecting rod connected to each of the plurality of clip members proximate the first lateral side.

9. The movable thermal shroud of claim 1, wherein
the mounting body comprises a mounting frame defining the framed opening;
each of the plurality of slats are movably connected in parallel to the mounting frame; and
the operation mechanism comprises a lever, wherein the lever is operatively connected to at least the first end of each of the plurality of slats and is configured to position the plurality of slats in the open configuration and the closed configuration.

10. A movable thermal shroud, comprising:
a mounting body comprising an elongated member rotatable about a rotational axis;
a plurality of slats, each having a first end, a second end opposite the first end, and opposite sides extending between the first end and the second end;
wherein the plurality of slats are connected together at the opposite sides in a side-by-side configuration,
wherein a first slat of the plurality of slats is connected to the elongated member,
wherein, when the elongated member is rotated to a closed configuration, the plurality of slats hang from the elongated member and enclose an inner equipment system, and
wherein, when the elongated member is rotated to an open configuration, at least a portion of the plurality of slats are wrapped around the elongated member, and a portion of the inner equipment system is accessible; and
an operation mechanism, wherein the operation mechanism is configured to rotate the elongated member between the closed configuration and the open configuration.

11. The movable thermal shroud of claim 10, wherein the operation mechanism is manually operated.

12. The movable thermal shroud of claim 10, wherein the operation mechanism is mechanically operated.

13. The movable thermal shroud of claim 10, wherein at least one sensor is positioned on an outer surface of the inner equipment system.

14. The movable thermal shroud of claim 13, wherein the at least one sensor is selected from the group consisting of a temperature sensor, a humidity sensor, a pressure sensor, and a toxic gas detector.

15. The movable thermal shroud of claim 10, wherein the operation mechanism comprises a gear assembly provided with the mounting body.

16. A method for monitoring an inner equipment system, comprising:
placing a movable thermal shroud around the inner equipment system, the movable thermal shroud comprising:
a mounting body; and
a plurality of slats connected to the mounting body,
wherein the plurality of slats are movable relative to the mounting body between a closed configuration and an open configuration,
wherein the plurality of slats are held in a stacked configuration relative to each other; and
an operation mechanism, wherein the operation mechanism is configured to position the plurality of slats in the closed configuration or in the open configuration,
moving the plurality of slats to the closed configuration using the operation mechanism to enclose the inner equipment system; and
moving the plurality of slats to the open configuration using the operation mechanism to access a portion of the inner equipment system.

17. The method of claim 16, wherein the operation mechanism is manually operated.

18. The method of claim 16, further comprising using at least one sensor mounted to an outer surface of the inner equipment system configured to monitor an environmental parameter around the movable thermal shroud, wherein the environmental parameter is selected from the group consisting of temperature, humidity, wind speed, pressure, and gas level.

19. The method of claim 18, further comprising:
using a computer system to interface with the at least one sensor; and
controlling, using the computer system, the operation mechanism based on the environmental parameter obtained from the at least one sensor.

20. The method of claim 19, wherein the operation mechanism is configured to automatically move the plurality of slats into the open configuration, or the closed configuration based on the environmental parameter obtained from the at least one sensor.
